(19) United States
(12) Patent Application Publication
(10) Pub. No.: US 2025/0335237 A1
(43) Pub. Date: Oct. 30, 2025

(54) SYSTEMS AND METHODS FOR IMPROVED HANDLING OF PROCESSOR INTERRUPTS

(71) Applicant: QUALCOMM Incorporated, San Diego, CA (US)

(72) Inventors: Utkarsh VINAYAK, Patna (IN); Chandrashekar Reddy KUNREDDY, Hyderabad (IN); Mohd SALMAN, Kiratpur (IN); Sharath Kumar NAGILLA, Hyderabad (IN)

(21) Appl. No.: 18/651,309

(22) Filed: Apr. 30, 2024

(51) Int. Cl. G06F 9/48; G06F 9/46

(52) U.S. Cl. CPC G06F 9/4818; G06F 9/462

(57) ABSTRACT

An apparatus includes a first interrupt priority register that maps a first portion of each nested interrupt identification (ID) value of a set of nested interrupt ID values to a first set of priority levels. Each of the first portions corresponds to one of the first set of priority levels. A second interrupt priority register maps a second portion of each nested interrupt ID value to a second set of priority levels, such that each nested interrupt ID value corresponds to two priority levels. The set of nested interrupt ID values corresponds to merged interrupt sources coupled to a single interrupt line.

### FIELD OF THE DISCLOSURE

Aspects of the present disclosure generally relate to computer systems, and more particularly to systems and methods for improved handling of processor interrupts.

### BACKGROUND

Interrupt handling is a process in computer systems where a processing unit, such as a central processing unit (CPU), temporarily halts current tasks to address a specific event or condition requiring more immediate attention. The event or condition is referred to as an interrupt. Interrupts may be generated in response to external events, such as input from a user or a network packet arrival, and/or internal events, such as the expiration of a timer or a software condition being satisfied. When an interrupt occurs, the processing unit saves the processing unit's current state and executes a specified portion of program code associated with the interrupt, referred to as an interrupt service routine (ISR) or interrupt handler. The processing unit, executing the interrupt service routine, services the interrupt by performing actions such as reading input data and transmitting hardware signals. Upon completion, the processing unit restores the previous state and resumes prior tasks. Interrupt handling enables processing units to manage multiple tasks and respond to real-time events.

### SUMMARY

In some aspects of the present disclosure, a method includes determining a first priority level for each nested interrupt ID value of a set of nested interrupt ID values. The first priority level is determined from a first interrupt priority register that maps a first portion of each nested interrupt ID value to the first priority level. The first priority level is from a first set of priority levels. The method also includes determining a second priority level for each nested interrupt ID value of the set of nested interrupt ID values. The second priority level is determined from a second interrupt priority register that maps a second portion of each nested interrupt ID value to the second priority level. The second priority level is from a second set of priority levels. The set of nested interrupt ID values corresponds to merged interrupt sources coupled to a single interrupt line.

Other aspects of the present disclosure are directed to an apparatus. The apparatus includes a first interrupt priority register that maps a first portion of each nested interrupt identification (ID) value of a set of nested interrupt ID values to a first set of priority levels. Each of the first portions corresponds to one of the first set of priority levels. The apparatus also includes a second interrupt priority register that maps a second portion of each nested interrupt ID value to a second set of priority levels, such that each nested interrupt ID value corresponds to two priority levels. The set of nested interrupt ID values corresponds to merged interrupt sources coupled to a single interrupt line.

In still other aspects of the present disclosure, a non-transitory computer-readable medium with program code recorded thereon is disclosed. The program code is executed by at least one processor and includes program code to determine a first priority level for each nested interrupt ID value of a set of nested interrupt ID values. The set of nested interrupt ID values is from a first interrupt priority register that maps a first portion of each nested interrupt ID value to the first priority level. The first priority level is from a first set of priority levels. The program code also includes program code to determine a second priority level for each nested interrupt ID value of the set of nested interrupt ID values from a second interrupt priority register that maps a second portion of each nested interrupt ID value to the second priority level. The second priority level is from a second set of priority levels. The set of nested interrupt ID values corresponds to merged interrupt sources coupled to a single interrupt line.

Other aspects of the present disclosure are directed to an apparatus. The apparatus includes means for determining a first priority level for each nested interrupt ID value of a set of nested interrupt ID values. The set of nested interrupt ID values is from a first interrupt priority register that maps a first portion of each nested interrupt ID value to the first priority level. The first priority level is from a first set of priority levels. The apparatus also includes means for determining a second priority level for each nested interrupt ID value of the set of nested interrupt ID values from a second interrupt priority register that maps a second portion of each nested interrupt ID value to the second priority level. The second priority level is from a second set of priority levels. The set of nested interrupt ID values corresponds to merged interrupt sources coupled to a single interrupt line.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a system-on-a-chip (SOC), in accordance with various aspects of the present disclosure.

FIG. 2 is a diagram illustrating an interrupt source register.

FIG. 3 is a block diagram illustrating interrupt sources in communication with a generic interrupt controller (GIC), in accordance with various aspects of the present disclosure.

FIG. 4 is a diagram illustrating values stored within interrupt registers, in accordance with various aspects of the present disclosure.

FIG. 5 is a flow diagram illustrating an improved process for interrupt handling, in accordance with various aspects of the present disclosure.

FIG. 6 is a flow diagram illustrating an example process performed, for example, by a processor, in accordance with various aspects of the present disclosure.

FIG. 7 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Several aspects of interrupt priority handling will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

As described, interrupt handling is a process in computer systems where a processing unit, such as a central processing unit (CPU), temporarily halts current tasks to address a specific event or condition requiring more immediate attention. During the interrupt handling process, a subsystem may produce an interrupt identification (ID) value corresponding to a pending interrupt. The subsystem may transmit the interrupt ID value to a CPU via a merged interrupt line. The CPU may then execute an interrupt service routine (ISR) associated with the interrupt ID value. However, if the subsystem includes multiple interrupt sources, then the CPU may read an interrupt source register within the subsystem to determine a specific interrupt service routine associated with the interrupt source. The CPU reads the interrupt source register sequentially, meaning that the CPU executes specific interrupt service routines according to the sequence in which the interrupt sources are indicated in the interrupt source register.

Conventional interrupt handling has drawbacks. For example, interrupt sources sharing a merged interrupt line may each be associated with an equal interrupt ID value. The CPU, therefore, may not be able to determine an interrupt source for the interrupt ID value until the CPU reads the interrupt source register in the subsystem associated with the interrupt ID value. Reading the interrupt source register takes time and energy. Reading the interrupt source register thus causes the CPU to be less efficient, especially if the CPU reads the interrupt source register for each interrupt received from the subsystem. Additionally, the CPU may address pending interrupts according to the sequence the interrupts are indicated in the interrupt source register. The CPU has no method to prioritize multiple interrupt sources sharing a merged interrupt line. Therefore, it would be desirable to improve interrupt handling.

Various aspects of the present disclosure are directed to systems and methods for improved handling of processor interrupts. In some aspects, a first interrupt priority register maps a first portion of a set of interrupt ID values to a first set of priority levels. A second interrupt priority register maps a second portion of the set of interrupt ID values to a second set of priority levels. Interrupt sources integrated with a shared subsystem may transmit a nested interrupt ID value to a generic interrupt controller within a CPU. A first portion of the nested interrupt ID value may be associated with a first priority level based on the priority levels stored in the first interrupt priority register. A second portion of the nested interrupt ID value may be associated with a second priority level based on the priority levels stored in the second interrupt priority register.

If multiple interrupts are pending, the first priority level and the second priority level associated with each pending interrupt may determine an order of priority. An interrupt distributor may then transmit the first portion of the interrupt ID value of the highest priority to a first interrupt acknowledgement register. The interrupt distributor may also transmit the second portion of the interrupt ID value of the highest priority to a second interrupt acknowledgement register. The CPU may then execute the highest priority pending interrupt, which is indicated by the first interrupt acknowledgment register and the second interrupt acknowledgment register.

Particular aspects of the subject matter described in this disclosure can be implemented to realize one or more of the following potential advantages. In some examples, the described techniques, such as transmitting a nested interrupt ID value, enables a CPU to determine the interrupt source of a pending interrupt without reading an interrupt source register. Because the CPU may determine the interrupt source of the pending interrupt without reading an interrupt source register, the CPU may take less time to service pending interrupts as compared to conventional methods. Another advantage is that the CPU may service pending interrupts according to an order of priority associated with the respective interrupt ID values, instead of servicing the interrupts according to the sequence indicated by an interrupt source register.

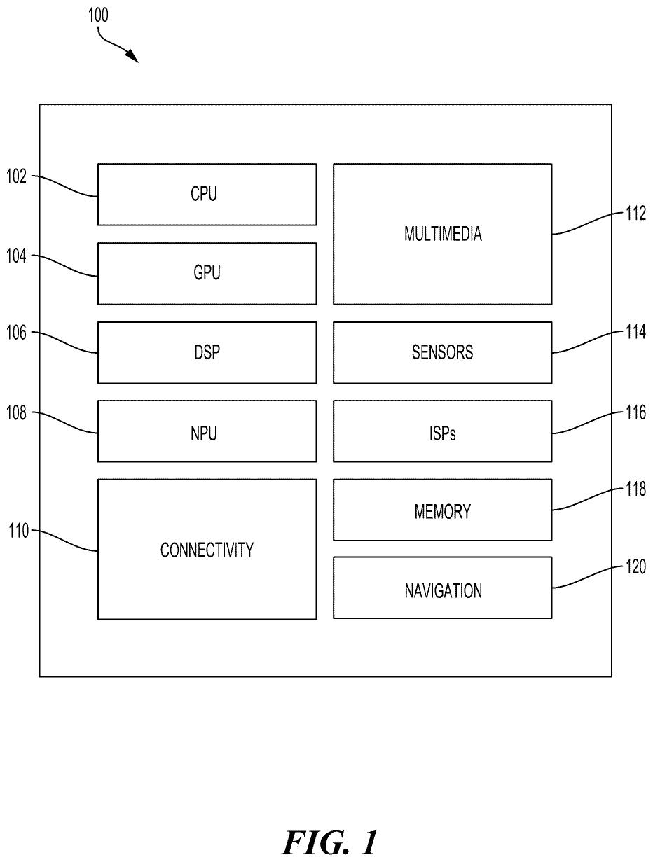

FIG. 1 illustrates an example implementation of a system-on-a-chip (SOC) 100, which may include a central processing unit (CPU) 102 or a multi-core CPU configured for interrupt handling. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the CPU 102 may include code to determine a first priority level for each nested interrupt ID value of a set of nested interrupt ID values. The first priority level may be from a first set of priority levels from a first interrupt priority register that maps a first portion of each nested interrupt ID value to the first priority level. The instructions loaded into the CPU 102 may also include code to determine a second priority level for each nested interrupt ID value of the set of nested interrupt ID values from a second interrupt priority register. The second interrupt priority register maps a second portion of each nested interrupt ID value to the second priority level, which is from a second set of priority levels. Additionally, the set of nested interrupt ID values corresponds to merged interrupt sources coupled to a single interrupt line.

According to aspects of the present disclosure, an apparatus includes a generic interrupt controller. The apparatus may include means for determining, means for receiving, and means for transmitting. For example, the means for determining may be any of the CPU 102, GPU 104, DSP 106, NPU 108, ISP 116, CPU 302, GIC 322, first interrupt source 304, second interrupt source 306, third interrupt source 308, first source line 314, second source line 316, third source line 318, interconnect 320, first interrupt priority register 400, or second interrupt priority register 410. The means for receiving may be any of the CPU 102, GPU 104, DSP 106, NPU 108, ISP 116, CPU 302, GIC 322, first interrupt source 304, second interrupt source 306, third interrupt source 308, first source line 314, second source line 316, third source line 318, interconnect 320, first interrupt acknowledgement register 420, or second interrupt acknowledgment register 430. The means for transmitting may be any of the CPU 102, GPU 104, DSP 106, NPU 108, ISP 116, CPU 302, GIC 322, first interrupt acknowledgement register 420, or second interrupt acknowledgment register 430. In other aspects, the aforementioned means may be any structure or any material configured to perform the functions recited by the aforementioned means.

As discussed, various aspects of the present disclosure are directed to interrupt handling, including the handling of shared peripheral interrupts (SPIs). Conventional systems for interrupt handling may include various subsystems. Examples of subsystems may include video devices and audio devices. Additionally, each of the subsystems may include multiple sources. For instance, a video subsystem may include three interrupt sources and an audio device may include five interrupt sources. In conventional interrupt handling techniques, interrupts are routed from subsystems to a CPU via a single interrupt line, referred to as a merged interrupt line. For example, three separate interrupt sources within a video subsystem may transmit interrupts to a CPU. In this example, the three individual interrupts may each merge onto the single interrupt line as they are transmitted to the CPU. At the CPU, a generic interrupt controller (GIC) receives the interrupts and performs an interrupt service routine (ISR) based on the interrupts. Interrupt service routines may also be referred to as interrupt handlers.

The interrupts each include an interrupt identification (ID) value. For interrupts transmitted from subsystems including multiple interrupt sources, each interrupt may have the same interrupt ID value. For example, interrupts transmitted from different sources within a video subsystem may each have an interrupt ID value of 5. Because the generic interrupt controller receives the interrupts from a single interrupt line and the interrupts each have the same interrupt ID value, the generic interrupt controller treats the individual interrupts as a single interrupt. The generic interrupt controller is therefore unable to prioritize the individual interrupts, and instead manages the individual interrupts as having an equal priority level. The generic interrupt controller may also receive additional interrupts from different subsystems. The additional interrupts are each associated with their own interrupt ID value and priority level.

At the generic interrupt controller, interrupt handling software acknowledges received interrupts based on the priority of interrupts, and the CPU executes an interrupt service routine specific to the interrupt. For example, an interrupt from a first subsystem having an interrupt ID value of 5 may be associated with a priority value of 0. An interrupt from a second subsystem having an interrupt ID value of 4 may be associated with a priority value of 1. In this example, the generic interrupt controller may first execute the interrupt service routine for the first subsystem's interrupt because the interrupt from the first subsystem is associated with a lower priority value.

The following example describes conventional interrupt handling. In this example, an exception is raised within a CPU, such as the CPU 102 described with respect to FIG. 1. Although the exception could be a fast interrupt request (FIQ) or a standard interrupt request (IRQ), the exception in this example is a standard interrupt request. A generic interrupt controller within the CPU implements an interrupt vector table that associates a list of interrupt handlers with a list of interrupt requests. Using the interrupt vector table, execution jumps to a top interrupt handler associated with the pending interrupt. The interrupt ID value for the pending interrupt is stored in a register at the CPU interface. For instance, the interrupt ID value may be stored in an interrupt acknowledgment register, such as a generic interrupt controller CPU interface interrupt acknowledgment register (GICC_IAR).

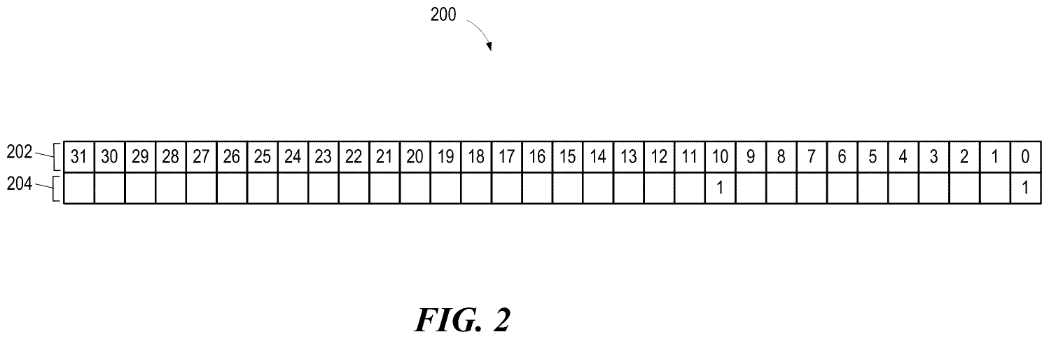

The CPU may read the GICC_IAR to determine the interrupt ID value of the pending interrupt and jump to a bottom interrupt handler to determine an interrupt service routine associated with the interrupt ID value. The bottom interrupt handler includes a one-dimensional array containing addresses of interrupt service routines corresponding to every raisable interrupt. The CPU determines the address of a parent interrupt service routine associated with the interrupt ID value stored within the GICC_IAR register. Upon executing the parent interrupt service routine, the CPU reads an interrupt source register associated with the parent interrupt service routine to determine a specific interrupt service routine. The CPU then executes the specific interrupt service routine. The process of reading the interrupt source register is further described with respect to FIG. 2.

FIG. 2 is a diagram illustrating an interrupt source register 200. The interrupt source register 200 may be an example of an interrupt source register stored within a subsystem (SS), such as a VCODEC_SS_IRQ_STATUS register stored within a video subsystem. The interrupt source register 200 may also be referred to as a status register. As shown in FIG. 2, the interrupt source register 200 includes a first row 202 and a second row 204. The first row 202 stores values in sequential order. In the example illustrated with respect to FIG. 2, the first row 202 stores whole numbers between and including 0 and 31. Each of the values may correspond to a respective interrupt source within the subsystem. For example, value 0 may correspond to interrupt source 0 in a video subsystem, while value 31 may correspond to interrupt source 31 in the video subsystem. The second row 204 stores a value of 1 for associated interrupt sources with pending interrupts. In the example illustrated with respect to FIG. 2, interrupt source 10 and interrupt source 0 both have a pending interrupt. The other interrupt sources do not have a pending interrupt.

As discussed, a CPU may execute an interrupt service routine upon receiving an interrupt from a subsystem. As part of a parent interrupt service routine, the CPU may read an interrupt source register within the subsystem to determine the interrupt sources within the subsystem that have pending interrupts. For example, the CPU may read the interrupt source register 200 and determine that interrupt source 10 and interrupt source 0 within the subsystem have pending interrupts. The CPU may then branch execution based on the pending interrupts by, for example, executing specific interrupt service routines based on interrupt source 10 and interrupt source 0.

The interrupt source register 200 polls from either the least significant bit (LSB) to most significant bit (MSB) or most significant bit to least significant bit. Because the interrupt source register 200 is polled sequentially from one end of the register to the other, interrupts may be serviced according to the interrupt's placement in the interrupt source register 200. For example, the interrupt source register 200 may receive interrupts from interrupt source 0 and interrupt source 10. The interrupt source register 200 may then indicate interrupt source 0 and interrupt source 10 as pending, as shown in FIG. 2. If interrupts are pending from both interrupt source 0 and interrupt source 10, and the interrupt source register 200 is polled from most significant bit to least significant bit, then the interrupt for interrupt source 10 is serviced first. In this example, the interrupt for interrupt source 10 is serviced before the interrupt for interrupt source 0, regardless of the order the interrupts were received. As demonstrated by this example, interrupts indicated by the interrupt source register 200 are serviced based on the sequential read of the register and not on a priority value or order of receipt.

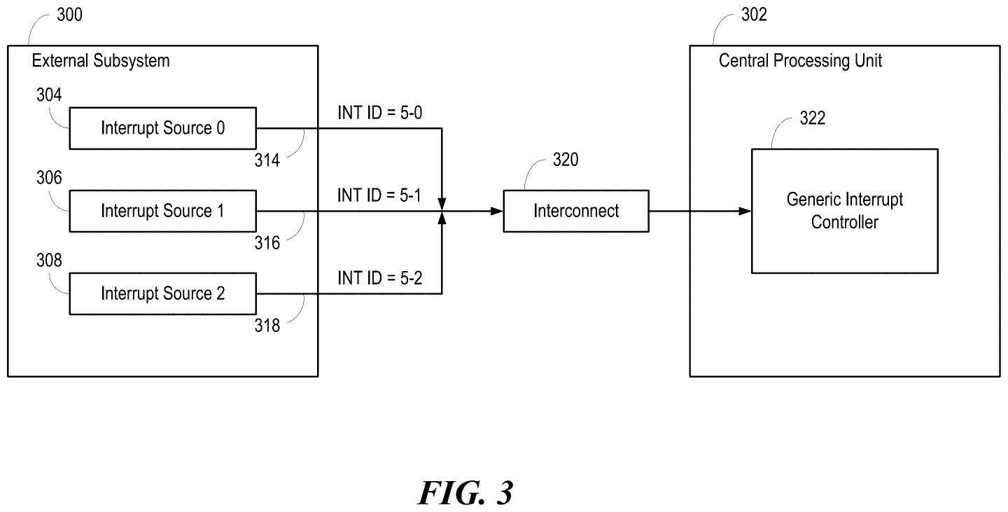

FIG. 3 is a block diagram illustrating interrupt sources in communication with a generic interrupt controller (GIC), in accordance with various aspects of the present disclosure. As shown in FIG. 3, an external subsystem 300 is in communication with a CPU 302 via an interconnect 320. The interconnect 320 may also be referred to as a single interrupt line. The external subsystem 300 includes a first interrupt source 304 coupled to the interconnect 320 via a first source line 314. The external subsystem 300 also includes a second interrupt source 306 coupled to the interconnect 320 via a second source line 316. The external subsystem 300 further includes a third interrupt source 308 coupled to the interconnect 320 via a third source line 318. The interconnect 320 is coupled to a generic interrupt controller 322 integrated with the CPU 302.

According to aspects of the present disclosure, the components illustrated in FIG. 3 may implement two-level priority values and two-level interrupt ID values to process interrupts without using an interrupt source register. Two-level priority values may also be referred to as nested priority values, and two-level interrupt ID values may also be referred to as nested interrupt ID values. In some implementations, the first interrupt source 304 may transmit, via the first source line 314 and interconnect 320, an interrupt ID value having two portions. The first portion may be associated with the external subsystem 300. The second portion may be associated with the first interrupt source 304.

The generic interrupt controller 322 may be in communication with other subsystems that are not illustrated in FIG. 3. One or more of the other subsystems may also include two or more interrupt sources, and nested interrupt ID values may be associated with each of the subsystems including two or more interrupt sources. In the example illustrated with respect to FIG. 3, the first interrupt source 304 transmits an interrupt ID value of 5-0, where 5 is associated with the external subsystem 300 and 0 is associated with the first interrupt source 304. Similarly, the second interrupt source 306 may transmit an interrupt ID of 5-1, and the third interrupt source 308 may transmit an interrupt ID of 5-2. Because the first interrupt source 304, second interrupt source 306, and third interrupt source 308 are each integrated with the external subsystem 300, each interrupt source may be associated with a same first interrupt ID portion, such as 5. However, each interrupt source may be associated with its own second interrupt ID portion, such as 0, 1, or 2. The hyphen shown between the first interrupt ID portion and second interrupt ID portion is for illustrative purposes and is not necessary to implement the two-level interrupt ID value.

The first source line 314, second source line 316, and third source line 318 each merge onto the interconnect 320. The interrupt sources may transmit a two-level interrupt ID value to the generic interrupt controller 322, and the generic interrupt controller 322 may store both the first portion and second portion of the two-level interrupt ID value within the CPU 302. To execute the pending interrupt, a CPU interface associated with the CPU 302 forwards pending interrupts to a processing element. The CPU 302, implementing interrupt software, then executes an interrupt service routine associated with the two-level interrupt ID value. Because the two-level interrupt ID value indicates the interrupt source associated with the pending interrupt, the CPU 302 may execute the interrupt service routine without reading an interrupt source register to determine the source of the pending interrupt.

The following is an example with respect to FIG. 3. In this example, the external subsystem 300 may be a video subsystem. The third interrupt source 308 transmits an interrupt ID value of 5-2 to the generic interrupt controller 322 via the third source line 318 and interconnect 320. The CPU 302 may then execute an interrupt service routine based on the pending interrupt. The CPU 302 may determine the source of the pending interrupt without reading a source register because the second interrupt ID portion of 2 already indicates the third interrupt source 308. The CPU 302 may therefore jump to an interrupt service routine specific to the third interrupt source 308 without reading a source register.

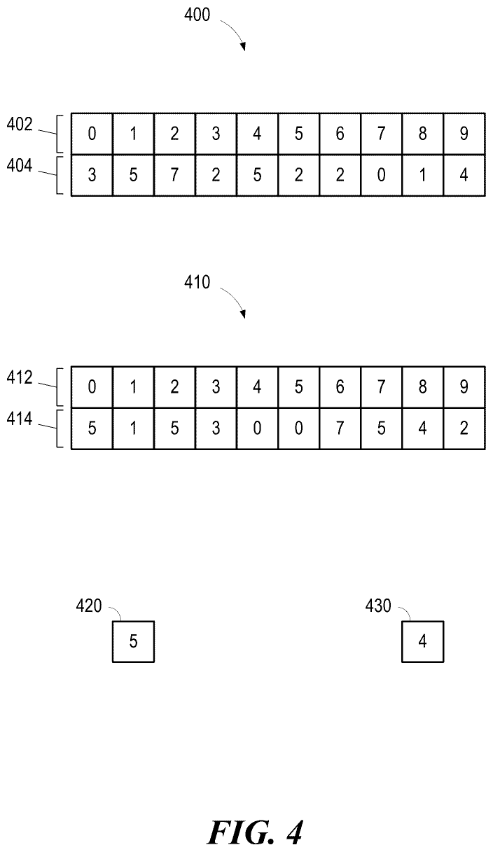

FIG. 4 is a diagram illustrating values stored within interrupt registers, in accordance with various aspects of the present disclosure. As shown in FIG. 4, a first interrupt priority register 400 maps first portions 402 of a set of two-level interrupt ID values to a first set of priority levels 404. Each of the first portions 402 correspond to a priority level in the first set of priority levels 404. For instance, a first portion 0 corresponds to a priority level 3, and a first portion 2 corresponds to a priority level 7. Similarly, a second interrupt priority register 410 maps second portions 412 of the set of two-level interrupt ID values to a second set of priority levels 414. Each of the second portions 412 correspond to a priority level in the second set of priority levels 414. For instance, a second portion 0 corresponds to a priority level 5, and a second portion 4 corresponds to a priority level 0.

The first interrupt priority register 400 and second interrupt priority register 410 map nested interrupt ID values to priority levels such that each nested interrupt ID value corresponds to two priority levels. For example, an interrupt ID value of 9-2 may correspond to a first priority level of 4 and a second priority level of 5. Therefore, the interrupt ID value of 9-2 may correspond to a nested priority level of 4-5 based on the values shown in FIG. 4.

The first interrupt priority register 400 and second interrupt priority register 410 may be integrated within a CPU, such as the CPU 102 illustrated in FIG. 1 or the CPU 302 illustrated in FIG. 3. For example, the first interrupt priority register 400 may be designated as GICD_IPRIORITYR<n> within the CPU, and the second interrupt priority register 410 may be designated as GICD_IPRIORITYR1<n>. The CPU may read the first interrupt priority register 400 and second interrupt priority register 410 upon receiving an interrupt. For example, if the CPU receives an interrupt ID value of 8-2, the CPU may read the first interrupt priority register 400 to determine that the interrupt is associated with a first priority level of 1, and the CPU may read the second interrupt priority register 410 to determine that the interrupt is associated with a second priority level of 5. The priority level of the received interrupt in this example is therefore 1-5.

It is also contemplated that some, but not all, interrupt IDs and priority levels contain nested values. For instance, the first interrupt priority register 400 may map a set of legacy interrupt ID values to a set of priority levels, where the term legacy interrupt ID value refers to single-level interrupt ID values. In some implementations, a subset of a total set of interrupt ID values may support nested interrupt ID values and nested priority levels. For example, a first portion between and including 0 and 4 may support legacy interrupt ID values but not nested interrupt ID values. A second portion between and including 5 and 9 may support nested interrupt ID values and priority levels. In this example, the CPU may receive two interrupts. A first interrupt includes an interrupt ID of 3, and a second interrupt includes an interrupt ID of 7-4. The CPU may then read the first interrupt priority register 400 to determine that the first interrupt is associated with a priority level of 2. The CPU may read the second interrupt priority register 410 to determine that the second interrupt is associated with a priority level of 0-0.

The first portion of interrupt IDs may correspond to subsystems having merged interrupt sources. For instance, if an audio device includes only one interrupt source, and a video device includes two or more interrupt sources that communicate to a generic interrupt controller via a single interrupt line, then the audio device may be associated with a legacy interrupt ID value and the video device may be associated with a nested interrupt ID value. If the CPU receives an interrupt with an interrupt ID value associated with the audio device, then the CPU may read the first interrupt priority register 400. If the CPU receives an interrupt with an interrupt ID value associated with the video device, then the CPU may read both the first interrupt priority register 400 and the second interrupt priority register 410.

Although the example illustrated with respect FIG. 4 shows ten first portions 402 and ten second portions 412, other quantities and arrangements are contemplated. For example, the first interrupt priority register 400 may include 164 first portions 402. The second interrupt priority register 410 may include 32 second portions 412. The first portions 402 reserved for nested interrupt ID values may be a nested set of the first portions 402, such as those between and including 100 and 163. If the CPU receives an interrupt ID value of 100-47, the CPU may read the first interrupt priority register 400 and the second interrupt priority register 410 to determine a priority value. For instance, the CPU may read the GICD_IPRIORITYR<n> register to determine a first priority value and the GICD_IPRIORITYR1<n> register to determine a second priority value.

The values shown in FIG. 4 are examples. The first portions 402, first set of priority levels 404, second portions 412, and second set of priority levels 414 may include different values than those shown. The values may also comprise different formats. For instance, the values may include letters, symbols, or binary. In some implementations, the first portions 402 and the second portions 412 may be addresses for priority levels stored in memory. For example, the generic interrupt controller may receive an interrupt ID value of 01011100, where 0101 is an address of a first priority value, and 1100 is an address of a second priority value. In still some implementations, the first portions 402 and the first set of priority levels 404 may be stored within the first interrupt priority register 400 as a set of data, one portion of the data including the first portions 402 and another portion of the data including the first set of priority levels 404. Similarly, the second portions 412 and the second set of priority levels 414 may be stored within the second interrupt priority register 410 as a set of data, one portion of the data including the second portions 412 and a second portion of the data including the second set of priority levels 414.

As shown in FIG. 4, a first interrupt acknowledgement register 420 is configured to store a first portion of a nested interrupt ID value. The stored first portion may be associated with a highest priority pending interrupt at a CPU interface. A second interrupt acknowledgement register 430 is configured to store a second portion of a nested interrupt ID value. The stored second portion may be associated with the highest priority pending interrupt at the CPU interface. For example, the CPU may receive a first interrupt having an interrupt ID value of 3-1 and a second interrupt having an interrupt ID value of 5-4. The first interrupt priority register 400 and second interrupt priority register 410 may indicate that the first interrupt has a priority level of 2-1 and the second interrupt has a priority level of 2-0.

An interrupt distributor may transmit the first portion of the nested interrupt ID value of the highest priority pending interrupt to the first interrupt acknowledgement register 420. The interrupt distributor may also transmit the second portion of the nested interrupt ID value of the highest priority pending interrupt to the second interrupt acknowledgement register 430. If the first priority level of a first interrupt is equal to the first priority level of a second interrupt, then the interrupt distributor may determine the order of priority between the two interrupts based on the second priority level. For example, if the CPU receives a first interrupt having an interrupt ID value of 3-1 and a second interrupt having an interrupt ID value of 5-4, the second interrupt has a higher priority of 2-0 as compared to the first interrupt's priority of 2-1, because the second interrupt is associated with a lower second priority level than the first interrupt. Therefore, the interrupt ID value for the second interrupt is stored in the first interrupt acknowledgment register 420 and second interrupt acknowledgment register 430. In this example, the first interrupt acknowledgment register 420 stores the first portion of 5 and the second interrupt acknowledgement register 430 stores the second portion of 4. The first interrupt acknowledgment register 420 and second interrupt acknowledgment register 430 may store values other than those illustrated in FIG. 4, depending on the pending interrupts.

As discussed, the interrupt distributor may determine an order of priority of two or more pending interrupts. The order of priority may be based on a first priority level associated with the first portion of a nested interrupt ID value. The order of priority may be further based on a second priority level associated with a second portion of the respective nested interrupt ID value. However, the CPU may receive interrupts associated with a single-level priority value in addition to interrupts associated with a two-level priority value. For example, a first interrupt may have a priority value of 3, while a second interrupt may have a priority value of 5-2. In this example, the interrupt distributor may treat 3 as the first priority level. The interrupt distributor may therefore place the first interrupt before the second interrupt in the order of priority because the first interrupt is associated with a lower priority value.

In some implementations, if a single-level priority value is equal to the first priority level of a nested priority level value, then the interrupt distributor may be configured to treat the single-level priority value as having a higher priority than the nested priority level value. For example, if a third interrupt has a priority value of 7, and a fourth interrupt has a priority value of 7-2, the interrupt distributor may treat the third interrupt as having a higher priority than the fourth interrupt. In still some implementations, if a single-level priority value is equal to the first priority level of a nested priority level value, then the interrupt distributor may be configured to treat the single-level priority value as having a lower priority than the nested priority level value. For example, if the third interrupt has a priority value of 7, and the fourth interrupt has a priority value of 7-2, the interrupt distributor may treat the third interrupt as having a lower priority than the fourth interrupt.

The first interrupt acknowledgment register 420 may be a generic interrupt controller CPU interface interrupt acknowledgment register (GICC_IAR). The second interrupt acknowledgment register 430 may be a GICC_IAR1. For instance, the GICC_IAR may store the first portion of an interrupt ID value for a highest priority pending interrupt at a CPU interface. The GICC_IAR1 may store the second portion of the interrupt ID value. In some examples, the highest priority pending interrupt may have a legacy interrupt ID value. If the highest priority pending interrupt has a legacy interrupt ID value, then the interrupt ID value may be stored in the first interrupt acknowledgment register 420. For example, if the highest priority pending interrupt has an interrupt ID value of 99, then the GICC_IAR may store a value of 99 in a bit field. If the highest priority pending interrupt has a two-level interrupt ID value of 100-47, then the GICC_IAR may store 100 in a first bit field and the GICC_IAR1 may store 47 in a second bit field. Therefore, the interrupt ID value of the highest priority pending interrupt may be a combination of the values stored by the first interrupt acknowledgment register 420 and the second interrupt acknowledgment register 430.

In some implementations, the first interrupt priority register 400, second interrupt priority register 410, first interrupt acknowledgement register 420, and second interrupt acknowledgement register 430 may be integrated with a CPU. For example, a GICD_IPRIORITYR<n> register, GICD_IPRIORITYR1<n> register, GICC_IAR, and GICC_IAR1 may be integrated with the CPU 302 illustrated with respect to FIG. 3.

The following example describes an improved software interrupt handling flow. In this example, a standard interrupt request exception is raised within a CPU. A generic interrupt controller within the CPU implements an interrupt vector table that associates a list of interrupt handlers with a list of interrupt requests. Using the interrupt vector table, execution jumps to a top interrupt handler associated with the pending interrupt. The interrupt ID value for the pending interrupt is stored in registers integrated with the CPU. For instance, a first portion of the interrupt ID value may be stored in a first interrupt acknowledgment register, such as a GICC_IAR. A second portion of the interrupt ID value may be stored in a second interrupt acknowledgment register, such as a GICC_IAR1.

The CPU may read the GICC_IAR and GICC_IAR1 to determine the interrupt ID value of the highest priority pending interrupt and jump to a bottom interrupt handler to determine an interrupt service routine associated with the interrupt ID value. The bottom interrupt handler includes a two-dimensional array containing addresses of interrupt service routines corresponding to every raisable interrupt. If the interrupt ID value is a legacy interrupt ID value, the first column of the array may store the address of an interrupt service routine for the interrupt ID value. If the interrupt ID value is a nested interrupt ID value, the second column of the array may store the address of an interrupt service routine for the interrupt ID value. The CPU may then jump to the address indicated by the array and execute the interrupt service routine.

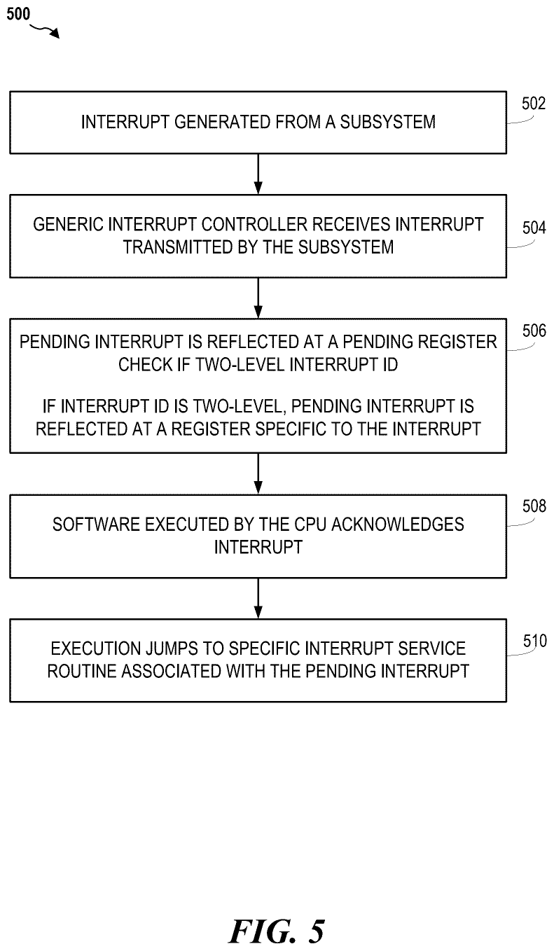

FIG. 5 is a flow diagram illustrating an improved process 500 for interrupt handling, in accordance with various aspects of the present disclosure. At block 502, the process 500 includes a subsystem generating an interrupt. For example, a video subsystem may generate an interrupt and transmit an interrupt ID value associated with the interrupt to a CPU. At block 504, a generic interrupt controller integrated with the CPU receives the interrupt ID value transmitted by the subsystem. The generic interrupt controller may receive the interrupt ID value via a single interrupt line.

At block 506, the pending interrupt is reflected at a pending register, such as the GICC_IAR. To service the interrupt, the CPU may determine if the interrupt ID value is a two-level interrupt ID value. If the interrupt ID value is a two-level interrupt ID value, then the pending interrupt is reflected at a register specific to the two-level interrupt ID value, such as the GICC_IAR1. At block 508, software executed by the CPU acknowledges the interrupt. For example, the software may transmit a signal to the subsystem to indicate that the CPU is servicing the pending interrupt. At block 510, execution jumps to the interrupt service routine associated with the pending interrupt. For instance, the CPU may execute the interrupt service routine associated with the interrupt ID value stored in the interrupt acknowledgment registers.

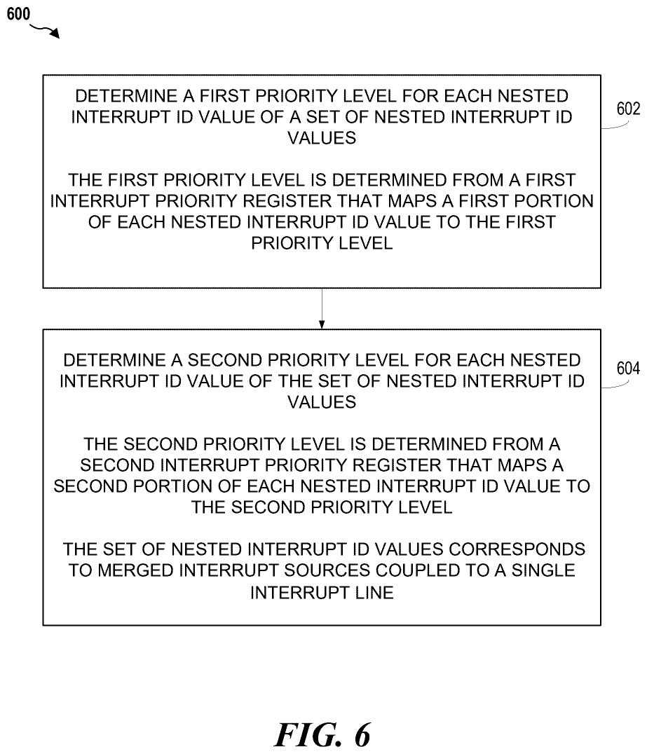

FIG. 6 is a flow diagram illustrating an example process 600 performed, for example, by a processor, in accordance with various aspects of the present disclosure. The process 600 may be performed by one or more processors, such as the CPU 102, GPU 104, and/or other processing unit.

In some aspects, the process 600 may include determining a first priority level for each nested interrupt ID value of a set of nested interrupt ID values (block 602). The first priority level is determined from a first interrupt priority register that maps a first portion of each nested interrupt ID value to the first priority level. The first priority level is from a first set of priority levels. Additionally, the set of nested interrupt ID values may be received from one or more subsystems including two or more interrupt sources. In some implementations, the first interrupt priority register also maps a set of legacy interrupt ID values to the first set of priority levels.

The process 600 may also include determining a second priority level for each nested interrupt ID value of the set of nested interrupt ID values (block 604). The second priority level is determined from a second interrupt priority register that maps a second portion of each nested interrupt ID value to the second priority level. The second priority level is from a second set of priority levels. Additionally, the set of nested interrupt ID values corresponds to merged interrupt sources coupled to a single interrupt line. Both the first interrupt priority register and the second interrupt priority register may be located within a CPU, such as the CPU 102 discussed with respect to FIG. 1.

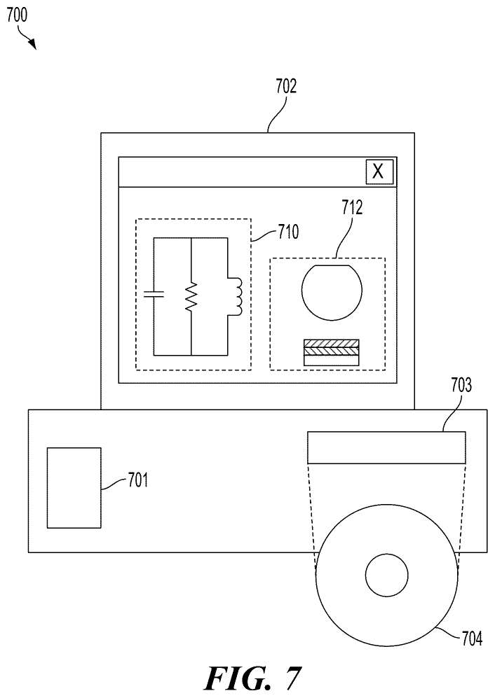

FIG. 7 is a block diagram illustrating a design workstation 700 used for circuit, layout, and logic design of a semiconductor component, such as the GICC_IAR1, external subsystem 300, and CPU 302 discussed above for FIG. 3. The design workstation 700 includes a hard disk 701 containing operating system software, support files, and design software such as Cadence or OrCAD. The design workstation 700 also includes a display 702 to facilitate design of a circuit 710 or a semiconductor component 712, such as the external subsystem 300 and CPU 302. A storage medium 704 is provided for tangibly storing the design of the circuit 710 or the semiconductor component 712 (e.g., the GICC_IAR1). The design of the circuit 710 or the semiconductor component 712 may be stored on the storage medium 704 in a file format such as GDSII or GERBER. The storage medium 704 may be a CD-ROM, DVD, hard disk, flash memory, or other appropriate device. Furthermore, the design workstation 700 includes a drive apparatus 703 for accepting input from or writing output to the storage medium 704.

Data recorded on the storage medium 704 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 704 facilitates the design of the circuit 710 or the semiconductor component 712 by decreasing the number of processes for designing semiconductor wafers.

### Example Aspects

Aspect 1: An apparatus, comprising: a first interrupt priority register mapping a first portion of each nested interrupt identification (ID) value of a set of nested interrupt ID values to a first set of priority levels, each first portion corresponding to one of the first set of priority levels; and a second interrupt priority register mapping a second portion of each nested interrupt ID value of the set of nested interrupt ID values to a second set of priority levels, such that each nested interrupt ID value corresponds to two priority levels, the set of nested interrupt ID values corresponding to merged interrupt sources coupled to a single interrupt line.

Aspect 2: The apparatus of Aspect 1, further comprising a first interrupt acknowledgement register configured to store the first portion of the nested interrupt ID value of a highest priority pending interrupt at a central processing unit (CPU) interface; and a second interrupt acknowledgement register configured to store the second portion of the nested interrupt ID value of the highest priority pending interrupt at the CPU interface.

Aspect 3: The apparatus of Aspect 1 or 2, in which the first interrupt priority register, second interrupt priority register, first interrupt acknowledgement register, and second interrupt acknowledgement register are integrated with a CPU.

Aspect 4: The apparatus of any of Aspects 1-3, further comprising an interrupt distributor configured to transmit the first portion of the nested interrupt ID value of the highest priority pending interrupt to the first interrupt acknowledgement register and the second portion of the nested interrupt ID value of the highest priority pending interrupt to the second interrupt acknowledgement register, the nested interrupt ID value transmitted based on an order of priority.

Aspect 5: The apparatus of any of Aspects 1-4, in which the order of priority is based on a first priority level of the first set of priority levels associated with the first portion of the nested interrupt ID value and a second priority level of the second set of priority levels associated with the second portion of the respective nested interrupt ID value.

Aspect 6: The apparatus of any of Aspects 1-5, in which the first interrupt priority register maps a set of legacy interrupt ID values to the first set of priority levels.

Aspect 7: The apparatus of any of Aspects 1-6, further comprising a set of subsystems, one or more subsystems of the set of subsystems including two or more interrupt sources, each nested interrupt ID value of the set of nested interrupt ID values associated with one of the one or more subsystems including two or more interrupt sources.

Aspect 8: A method, comprising: determining a first priority level for each nested interrupt ID value of a set of nested interrupt ID values from a first interrupt priority register mapping a first portion of each nested interrupt ID value to the first priority level, which is from a first set of priority levels; and determining a second priority level for each nested interrupt ID value of the set of nested interrupt ID values from a second interrupt priority register mapping a second portion of each nested interrupt ID value to the second priority level, which is from a second set of priority levels, the set of nested interrupt ID values corresponding to merged interrupt sources coupled to a single interrupt line.

Aspect 9: The method of Aspect 8, further comprising: receiving, at a first interrupt acknowledgement register, the first portion of the nested interrupt ID value of a highest priority pending interrupt at a central processing unit (CPU) interface; and receiving, at a second interrupt acknowledgement register, the second portion of the nested interrupt ID value of the highest priority pending interrupt at the CPU interface.

Aspect 10: The method of Aspect 8 or 9, in which the first interrupt priority register, second interrupt priority register, first interrupt acknowledgement register, and second interrupt acknowledgement register are integrated with a CPU.

Aspect 11: The method of any of Aspects 8-10, further comprising: transmitting the first portion of the nested interrupt ID value of the highest priority pending interrupt to the first interrupt acknowledgement register; and transmitting the second portion of the nested interrupt ID value of the highest priority pending interrupt to the second interrupt acknowledgement register, the nested interrupt ID value transmitted based on an order of priority, the order of priority based on the first priority level and the second priority level associated with the respective nested interrupt ID value.

Aspect 12: The method of any of Aspects 8-11, in which the first interrupt priority register maps a set of legacy interrupt ID values to the first set of priority levels.

Aspect 13: The method of any of Aspects 8-12, further comprising receiving, from one or more subsystems including two or more interrupt sources, the set of nested interrupt ID values.

Aspect 14: An apparatus, comprising: means for determining a first priority level for each nested interrupt ID value of a set of nested interrupt ID values from a first interrupt priority register mapping a first portion of each nested interrupt ID value to the first priority level, which is from a first set of priority levels; and means for determining a second priority level for each nested interrupt ID value of the set of nested interrupt ID values from a second interrupt priority register mapping a second portion of each nested interrupt ID value to the second priority level, which is from a second set of priority levels, the set of nested interrupt ID values corresponding to merged interrupt sources coupled to a single interrupt line.

Aspect 15: The apparatus of Aspect 14, further comprising: means for receiving, at a first interrupt acknowledgement register, the first portion of the nested interrupt ID value of a highest priority pending interrupt at a central processing unit (CPU) interface; and means for receiving, at a second interrupt acknowledgement register, the second portion of the nested interrupt ID value of the highest priority pending interrupt at the CPU interface.

Aspect 16: The apparatus of Aspect 14 or 15, in which the first interrupt priority register, second interrupt priority register, first interrupt acknowledgement register, and second interrupt acknowledgement register are integrated with a CPU.

Aspect 17: The apparatus of any of Aspects 14-16, further comprising: means for transmitting the first portion of the nested interrupt ID value of the highest priority pending interrupt to the first interrupt acknowledgement register; and means for transmitting the second portion of the nested interrupt ID value of the highest priority pending interrupt to the second interrupt acknowledgement register, the nested interrupt ID value transmitted based on an order of priority.

Aspect 18: The apparatus of any of Aspects 14-17, in which the order of priority is based on the first priority level and the second priority level associated with the respective nested interrupt ID value.

Aspect 19: The apparatus of any of Aspects 14-18, in which the first interrupt priority register maps a set of legacy interrupt ID values to the first set of priority levels.

Aspect 20: The apparatus of any of Aspects 14-19, further comprising means for receiving, from one or more subsystems including two or more interrupt sources, the set of nested interrupt ID values.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. An apparatus, comprising:
a first interrupt priority register mapping a first portion of each nested interrupt identification (ID) value of a set of nested interrupt ID values to a first set of priority levels, each first portion corresponding to one of the first set of priority levels; and
a second interrupt priority register mapping a second portion of each nested interrupt ID value of the set of nested interrupt ID values to a second set of priority levels, such that each nested interrupt ID value corresponds to two priority levels, the set of nested interrupt ID values corresponding to merged interrupt sources coupled to a single interrupt line.

2. The apparatus of claim 1, further comprising:
a first interrupt acknowledgement register configured to store the first portion of the nested interrupt ID value of a highest priority pending interrupt at a central processing unit (CPU) interface; and
a second interrupt acknowledgement register configured to store the second portion of the nested interrupt ID value of the highest priority pending interrupt at the CPU interface.

3. The apparatus of claim 2, in which the first interrupt priority register, second interrupt priority register, first interrupt acknowledgement register, and second interrupt acknowledgement register are integrated with a CPU.

4. The apparatus of claim 2, further comprising an interrupt distributor configured to transmit the first portion of the nested interrupt ID value of the highest priority pending interrupt to the first interrupt acknowledgement register and the second portion of the nested interrupt ID value of the highest priority pending interrupt to the second interrupt acknowledgement register, the nested interrupt ID value transmitted based on an order of priority.

5. The apparatus of claim 4, in which the order of priority is based on a first priority level of the first set of priority levels associated with the first portion of the nested interrupt ID value and a second priority level of the second set of priority levels associated with the second portion of the respective nested interrupt ID value.

6. The apparatus of claim 1, in which the first interrupt priority register maps a set of legacy interrupt ID values to the first set of priority levels.

7. The apparatus of claim 1, further comprising a set of subsystems, one or more subsystems of the set of subsystems including two or more interrupt sources, each nested interrupt ID value of the set of nested interrupt ID values associated with one of the one or more subsystems including two or more interrupt sources.

8. A method, comprising:
determining a first priority level for each nested interrupt ID value of a set of nested interrupt ID values from a first interrupt priority register mapping a first portion of each nested interrupt ID value to the first priority level, which is from a first set of priority levels; and
determining a second priority level for each nested interrupt ID value of the set of nested interrupt ID values from a second interrupt priority register mapping a second portion of each nested interrupt ID value to the second priority level, which is from a second set of priority levels, the set of nested interrupt ID values corresponding to merged interrupt sources coupled to a single interrupt line.

9. The method of claim 8, further comprising:
receiving, at a first interrupt acknowledgement register, the first portion of the nested interrupt ID value of a highest priority pending interrupt at a central processing unit (CPU) interface; and
receiving, at a second interrupt acknowledgement register, the second portion of the nested interrupt ID value of the highest priority pending interrupt at the CPU interface.

10. The method of claim 9, in which the first interrupt priority register, second interrupt priority register, first interrupt acknowledgement register, and second interrupt acknowledgement register are integrated with a CPU.

11. The method of claim 9, further comprising:
transmitting the first portion of the nested interrupt ID value of the highest priority pending interrupt to the first interrupt acknowledgement register; and
transmitting the second portion of the nested interrupt ID value of the highest priority pending interrupt to the second interrupt acknowledgement register, the nested interrupt ID value transmitted based on an order of priority, the order of priority based on the first priority level and the second priority level associated with the respective nested interrupt ID value.

12. The method of claim 8, in which the first interrupt priority register maps a set of legacy interrupt ID values to the first set of priority levels.

13. The method of claim 8, further comprising receiving, from one or more subsystems including two or more interrupt sources, the set of nested interrupt ID values.

14. An apparatus, comprising:
means for determining a first priority level for each nested interrupt ID value of a set of nested interrupt ID values from a first interrupt priority register mapping a first portion of each nested interrupt ID value to the first priority level, which is from a first set of priority levels; and
means for determining a second priority level for each nested interrupt ID value of the set of nested interrupt ID values from a second interrupt priority register mapping a second portion of each nested interrupt ID value to the second priority level, which is from a second set of priority levels, the set of nested interrupt ID values corresponding to merged interrupt sources coupled to a single interrupt line.

15. The apparatus of claim 14, further comprising:
means for receiving, at a first interrupt acknowledgement register, the first portion of the nested interrupt ID value of a highest priority pending interrupt at a central processing unit (CPU) interface; and
means for receiving, at a second interrupt acknowledgement register, the second portion of the nested interrupt ID value of the highest priority pending interrupt at the CPU interface.

16. The apparatus of claim 15, in which the first interrupt priority register, second interrupt priority register, first interrupt acknowledgement register, and second interrupt acknowledgement register are integrated with a CPU.

17. The apparatus of claim 15, further comprising:
means for transmitting the first portion of the nested interrupt ID value of the highest priority pending interrupt to the first interrupt acknowledgement register; and
means for transmitting the second portion of the nested interrupt ID value of the highest priority pending interrupt to the second interrupt acknowledgement register, the nested interrupt ID value transmitted based on an order of priority.

18. The apparatus of claim 17, in which the order of priority is based on the first priority level and the second priority level associated with the respective nested interrupt ID value.

19. The apparatus of claim 14, in which the first interrupt priority register maps a set of legacy interrupt ID values to the first set of priority levels.

20. The apparatus of claim 14, further comprising means for receiving, from one or more subsystems including two or more interrupt sources, the set of nested interrupt ID values.
